(19) United States
(12) Patent Application Publication
(10) Pub. No.: US 2005/0200190 A1
(43) Pub. Date: Sep. 15, 2005

(54) Dump trailer

(76) Inventor: Charles J. Nye JR., Lewiston, ME (US)

Correspondence Address: BOHAN, MATHERS & ASSOCIATES, LLC, PO BOX 17707, PORTLAND, ME, 04112-8707, US

(21) Appl. No.: 10/799,113

(22) Filed: Mar. 12, 2004

(51) Int. Cl. B62B 1/00

(52) U.S. Cl. 298/5

(57) ABSTRACT

Dump trailer that hitches to a tow vehicle and easily tilts to a dump position when the tow vehicle is backed up toward the dump trailer. The dump trailer has a tow bar assembly that is pivotably mounted on the front end of the trailer and pushes the body of the trailer to a tilted position when the tow vehicle backs up. The tow bar assembly includes an auxiliary wheel, allowing the trailer to be maintained in its horizontal position when not hitched to a tow vehicle. Also included is a work tray that is mounted on the handlebar of a small lawn trailer. An elevation sub-structure is also provided for larger utility trailers, that raises the trailer body so that the dump trailer can be brought to a 45-degree tilt angle for optimal dumping.

### BACKGROUND INFORMATION

1. Field of the Invention

The invention relates to the field of yard trailers. More particularly, the invention relates to yard trailers that tilt or dump.

2. Description of the Prior Art

The use of small lawn or yard trailers by homeowners and small businesses is quite common. Such trailers are useful for a variety of tasks, such as collecting and hauling away lawn debris or construction materials. The typical lawn trailer is a single-axle trailer that hitches to the back of a tow vehicle. The trailer has a flat bed and three fixed side walls and a removable or openable rear wall. The main disadvantage of the conventional lawn trailer is that it is not tiltable. The material to be hauled in the trailer is generally loaded into and unloaded from the trailer manually. The loading/unloading tasks are time-consuming and are strenuous, often arduous tasks that physically strain the person performing the loading or unloading. Many persons have physical handicaps, such as a bad or weak back, which makes loading or unloading a trailer a painful, if not an impossible, task.

For these reasons, it is desirable to have a lawn trailer that is tiltable for dumping, thereby eliminating at least the physically strenuous task of unloading. The problem has long been recognized, and a number of solutions have been put forward over the years. The disadvantage of these known solutions is that the sub-structure for dumping the trailer is complicated or extensive, making it either difficult to operate the dumping mechanism or expensive to manufacture. It is also desirable to provide a dumping structure that is retrofittable to an existing conventional lawn trailer.

A further disadvantage of the conventional lawn trailer is that the forward end slopes downward when it is not hitched to a tow vehicle. There are many uses of a trailer in which it is desirable to maintain the body of the trailer or, at least, the handlebars, horizontal. For example, one may use the body of the trailer or a surface placed across the handlebars as a work surface. A small lawn trailer, for example, could serve a dual purpose as a trailer/wheelbarrow, if it stayed in a horizontal orientation when not hitched to the tow vehicle.

What is needed, therefore, is a trailer that is dumpable, with only the force of a tow vehicle required to dump the trailer. What is further needed is such a trailer with a dumping means that is easy to use and increases the versatility of the trailer. What is yet further needed is such a dumping means that is retrofittable on a conventional lawn trailer. What is still yet further needed is such a dumping means that maintains an operational horizontal position of the trailer when not connected to the tow vehicle.

### BRIEF SUMMARY OF THE INVENTION

For the reasons cited above, it is an object of the present invention to provide a dump trailer that is brought to the dump position by the force of the tow vehicle. It is a further object to provide such a trailer with a dumping means that is easy to use and improves the versatility of the trailer. It is a yet further object to provide such a dumping mechanism that is retrofittable on a conventional lawn trailer. It is a still yet further object to provide such a dumping means that holds the trailer in its operational horizontal position when not connected to the tow vehicle.

The objects of the invention are achieved by providing a trailer having a modified a tow bar assembly that is pivotably attached to the front end of the trailer body of a trailer. To bring the trailer to the dump position, the tow bar assembly is hitched to the tow vehicle and the trailer wheels blocked or locked from rolling backward. When the tow vehicle is backed up toward the trailer, the tow bar assembly pivots relative to the trailer body, thereby pushing up the front end of the trailer body to the dump position. When the tow vehicle is driven forward, the increasing distance between tow vehicle and dump trailer pulls the front end of the trailer body down to its operational horizontal position. The term “operational horizontal position” refers to the position of the trailer body when the trailer bed is parallel with the ground surface.

The dump trailer according to the invention comprises a trailer body mounted on a single axle with a pair of wheels and a tow bar assembly according to the invention. The tow bar assembly includes a tow bar and an extension bar, which are provided with adjustment holes at their respective tow ends for adjustably setting the overall length of the tow bar assembly. A tow coupler means is attached to the tow hitch end of the extension bar for coupling the tow bar assembly with the tow hitch on the tow vehicle. Some means of preventing the trailer wheels from rolling backward during the dump operation are needed. A wheel chock or wheel brakes, such as electrical, mechanical, hydraulic brakes, may be used to block or lock the trailer wheels.

The dump trailer according to the invention includes several optional features, such as an auxiliary wheel and/or a work surface. The auxiliary wheel is provided to maintain the dump trailer in it operational horizontal position when it is not hitched to the tow vehicle. The auxiliary wheel assembly includes a wheel-assembly bar that is rotatable between a functional position and a non-functional position. In the functional position, the wheel is suspended downward from the wheel-assembly bar and comes into contact with the ground surface, in which position it maintains the dump trailer in a horiziontal orientation. In the non-functional position, the auxiliary wheel is swung upward, so that it is out of the way when the dump trailer is being towed. If the auxiliary wheel is included in the tow bar assembly, the extension bar is slidingly mounted in the wheel-assembly bar. When the wheel assembly is brought into the functional position, the tow coupler means on the extension bar is facing toward the trailer body and prevents hitching the dump trailer to the tow vehicle; when in the non-functional position, the tow coupler means is facing away from the trailer body and allows hitching of the dump trailer to the tow vehicle.

A further optional feature of the dump trailer according to the invention is a work surface that is mounted or provided on the handlebars of the trailer. A lawn trailer is often used for garden work, and it is very convenient to have a substantially flat surface at a comfortable working height for performing certain tasks. The work surface may be provided in several embodiments. In one, it is a flat tray with very short sidewalls and is fixedly attached to the handlebars. In another, the work surface is a flat container with side walls and the bottom of the work surface is formed so that the container is securely seated atop and/or between the handlebars.

It is within the scope of the invention to provide alternative embodiments of the dump trailer. The unifying feature of all these embodiments is that the tow bar assembly for bringing the trailer body into the dump position is pivotably mounted on the front face of the trailer body. One alternative embodiment includes a tow bar assembly that allows the use of a conventional ball-hitch. The tow bar assembly includes a telescoping tow bar and a fixed-length push bar assembly. In this case, the telescoping tow bar must remain horizontal throughout the dumping process. The fixed-length push bar assembly is a forked bar that is pivotably attached at one end to two points on the front face of the trailer and at the other end to the tow-hitch end of the telescoping tow bar. The tow-hitch end of the telescoping bar has a ball-coupler for coupling with the ball hitch; the other end of the telescoping tow bar is attached to the bottom of the trailer body, some distance behind the single axle. The wheels are blocked from rolling backward and as the tow vehicle backs up and the telescoping tow bar becomes shorter in length, the fixed-length push bar assembly forces the front end of the trailer body up, bringing the trailer to the dump position.

In a second alternative embodiment of the dump trailer according to the invention, a tilt control means is provided that will allow the trailer to be locked into a desired tilt angle. The tow bar assembly of this embodiment includes a set of dual push bars, each bar pivotably attached to an upper front corner of the trailer body. The tilt-control means comprises a pair of plates mounted on the tow bar assembly and a plate-locking mechanism. One plate is mounted at the top of each push bar such that the plate, when the orientation of the push bar changes to a more vertical position, the plate moves backward alongside the side wall of the trailer body. A series of locking holes is provided on the perimeter of the tilt-control plates. The plate-locking mechanism allows the two plates to be locked into a particular position, thereby holding the trailer in a particular tilt. The tow bar assembly must be pivotably hitchable to the tow hitch on the tow vehicle. Thus, a pintle coupler, with pintle hook and eye, is a suitable tow-coupler means for this embodiment, because it allows the angle of the dual push bars to change with regard to the vertical as the dump trailer is brought to the dump position.

A further feature of the dump trailer according to the invention is an elevating sub-structure that raises the trailer body to an elevated height that is higher than its normal distance from the axle. The advantage of raising a trailer body to this elevated height is that, particularly with larger trailer bodies, it allows the dump trailer to be brought to a steeper dump angle without the rear end of the dump trailer hitting the ground. The elevating sub-structure is mounted on the axle and, by means of a collapsing rod configuration, raises or lowers the trailer body.

### BRIEF DESCRIPTION OF THE DRAWINGS

The present invention is described with reference to the accompanying drawings. In the drawings, like reference numbers indicate identical or functionally similar elements. Drawings are not drawn to scale.

FIG. 1 is a side view of the dump trailer according to the invention, shown in its operational horizontal position, supported by the auxiliary wheel.

FIG. 2 is a side view of the dump trailer of FIG. 1, shown in its dump position.

FIG. 3 is a top view of the dump trailer of FIG. 1.

FIG. 4 is a side view of a modified dump trailer that include a work surface mounted on the handlebars.

FIG. 5A is an illustration of a modified tow bar assembly, with an extension bar, but without the auxiliary wheel.

FIG. 5B is a top view of the modified tow bar assembly of FIG. 5A.

FIG. 6 is a side view of a first alternative embodiment of the dump trailer according to the invention, shown in the dump position.

FIG. 7 is a side view of the dump trailer of FIG. 6, shown in the dump position.

FIG. 8 is a top view of the dump trailer of FIG. 6.

FIG. 9A is an illustration of the tilt-locking bar, shown locking the tilt plates in a particular position.

FIG. 9B is an illustration of the tilt-locking bar, shown in a released state, allowing the tilt plates to pivot about their pivot anchor.

FIG. 10 is a side view of a second alternative embodiment of the dump trailer according to the invention, shown in the dump position.

FIG. 11 is a side view of the third embodiment of the dump trailer of FIG. 10, shown in the tow position.

FIG. 12 is a side view of an elevated trailer according to the invention, showing the elevating sub-structure in its fully extended position.

FIG. 13 is a side view of the trailer of FIG. 12, showing the elevating sub-structure in it collapsed state.

FIG. 14A is a partial frontal view of the trailer if FIG. 12, showing the front elements of the elevating sub-structure in its deployed state.

FIG. 14B is a partial frontal view of the trailer of FIG. 12, showing the front elements of the elevating sub-structure in a collapsed state.

FIG. 15A is a partial rear view of the trailer of FIG. 12, showing the rear elements of the elevating sub-structure in its deployed state.

FIG. 15B is a partial rear view of the trailer of FIG. 12B, showing the rear elements of the elevating sub-structure in its collapsed state.

FIG. 16 illustrates a capture means for securing the sliding rail in a groove and a locking means for locking the sliding rail in a particular orientation.

### DETAILED DESCRIPTION OF THE INVENTION

Several embodiments of the dump trailer according to the invention are described below. The underlying principle of all the embodiments of the dump trailer is that the trailer is raised to a dump position from its operational horizontal position simply by using the power of a tow vehicle T. The tow vehicle T is shown in these illustrations generally as the rear end of a pickup truck or a lawn tractor, but it shall be understood that the tow vehicle may be any suitable vehicle, including, but not limited to, a passenger automobile, a truck, a recreational vehicle, such as a four-wheeler, a riding lawn mower, and a tractor. The trailers described hereinafter include a trailer body with two side walls, a front wall, and a rear wall. The trailer body is symmetrical about a longitudinal axis that extends from a front end F to a rear end R, with two wheels W mounted on the ends of a single axle A, and a tow bar according to the invention. The shape of the trailer body is not necessarily rectangular, however, in that the rear end R of the trailer body may be wider than the front end F. The front end F is a general designation that encompasses the area of the front wall, as well as the areas of the side walls and the trailer bottom that are close to the front wall. Similarly, the rear end R includes the area of the rear wall, as well as the areas of the side walls and trailer bottom that are close to the rear wall. The tow bar is pivotably attached to the front end F of the trailer body and, by first blocking or locking the wheels of the trailer to prevent them from rolling backward, the trailer is raised to the dump position by backing the tow vehicle T toward the dump trailer. With the tow vehicle T moving toward the trailer, the tow bar forces the front end F of the trailer up, bringing the trailer body to the dump position. Driving the tow vehicle T forward automatically restores the trailer to its operational horizontal position.

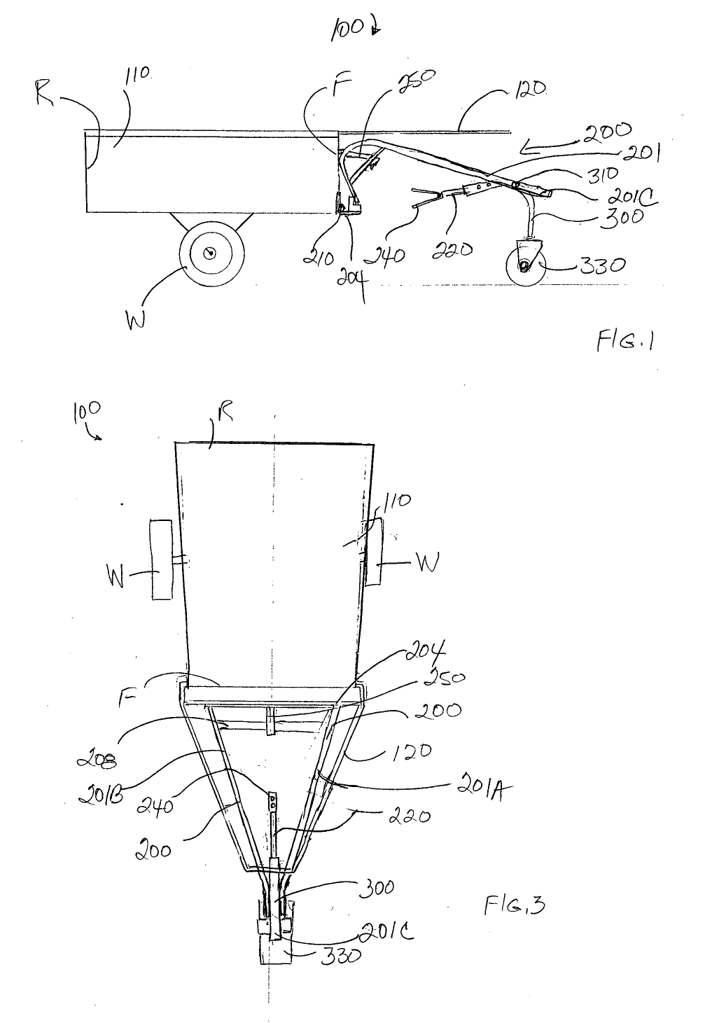

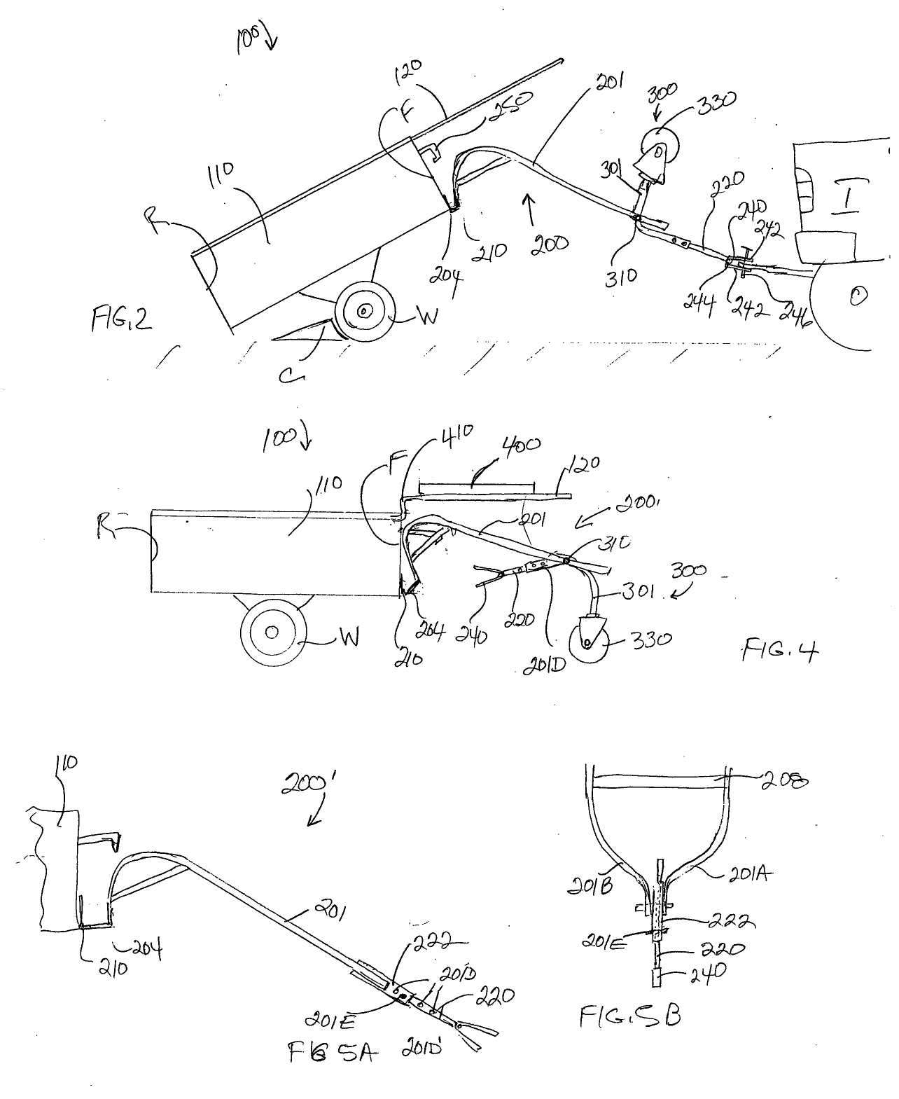

FIGS. 1-3 illustrate a preferred embodiment of a dump trailer 100 according to the invention. FIGS. 1 and 3 show the dump trailer 100 in its operational horizontal position, while FIG. 2 shows the dump trailer is its dump position. The dump trailer 100 comprises a trailer body 110, a trailer handle 120, and a tow bar assembly 200. The preferred embodiment also includes an auxiliary wheel assembly 300. The tow bar assembly 200 includes a dual bar 201 and is rigidly attached to the trailer body 100 by a pivot attachment means 210. In the embodiment shown, the pivot attachment means 210 includes a bracket 204 that is securely attached to the front end F of the trailer body 110 by a hinge 210. The dual-bar tow bar 201 comprises a first bar 201A and a second bar 201B, best seen in FIG. 3. The first and second bars are 201A/201B mirror images of each other and extend forward from the trailer body 110 and terminate at a forward end 201C of the dual bar 201. A tow coupler means 240 is used to hitch the dump trailer 100 to the tow vehicle T. The tow coupler means 240 shown in the preferred embodiment is a pair of connector plates 242, pivotably joined by a hinge 244. As shown in FIG. 2, when hitched to the tow vehicle T, a safety pin 246 is used to secure the connector plates 242 to the two hitch of the tow vehicle T.

The auxiliary wheel assembly 300 is rotatably mounted at the forward end 201C of the dual bar 201. The purpose of the auxiliary wheel assembly 300 is to maintain the dump trailer 100 in a horizontal orientation when it is not hitched to the tow vehicle T, allowing the dump trailer 100 to be used similar to a conventional three-wheeled wheelbarrow, as illustrated in FIG. 2. The auxiliary wheel assembly includes a wheel 330 that is freely rotatable about a vertical axis and that is mounted on a rigid curved bar 301. The curved bar 301 is captured between the first and second bars 201A,201B by means of a pin that extends through bores in the first and second bars 201A,201B and the curved bar 301, thereby allowing the curved bar 301 to rotate about the pin from a non-functional position, shown in FIG. 1, to a functional position shown in FIG. 2. In the functional position, the wheel assembly 300 is rotated down, with the wheel 330 extending down and supporting the forward end 201C of the tow bar assembly 200. In the non-functional position, the auxiliary wheel assembly 300 is rotated so that the wheel 330 extends upward away. Note that the tow coupler means 240 is connected to the end of the curved bar 301 such that the wheel assembly 300 is prevented from remaining in the functional position when the dump trailer 100 is hitched to the tow vehicle T.

With continued reference to FIGS. 1-3, an extension bar 220 is slidingly inserted into an end of the curved bar 301. Both the curved bar 301 and the extension bar 220 have extension holes 201D, for adjusting the length of the extension bar 220. This allows the distance between the dump trailer 100 to be shortened to a minimum when it is being towed by the tow vehicle T and easily and quickly extended when preparing the dump trailer 100 for dumping. Extending the tow bar assembly 200 by means of the extension bar 220 permits the dump trailer 100 to be moved to a greater tilt during the dumping process.

FIG. 4 illustrates a work surface 400 that is supported by the handlebars 120. The work surface 400 is an optional accessory for the dump trailer 100 according to the invention and is not limiting in the scope of the invention. The work surface 400, in the embodiment shown, is a flat, shallow tray that is fixedly mounted on the handlebars 120. Depending on the intended routine use for the dump trailer 100, it is, of course, possible to provide a container with higher side walls, or to provide a tray that is shaped on the bottom so as to be seatable on the handlebars 120 without being permanently attached to the handlebars 120. An additional optional feature of the dump trailer 100 shown in FIG. 4 is the raised handlebars 120. The attachment of the handlebars 120 to the trailer body 110 has been modified to raise the horizontal level of the handlebars 120 to a height that provides a more comfortable work surface height. In the embodiment shown, the modification is achieved by adding an S-shaped attachment bar 410.

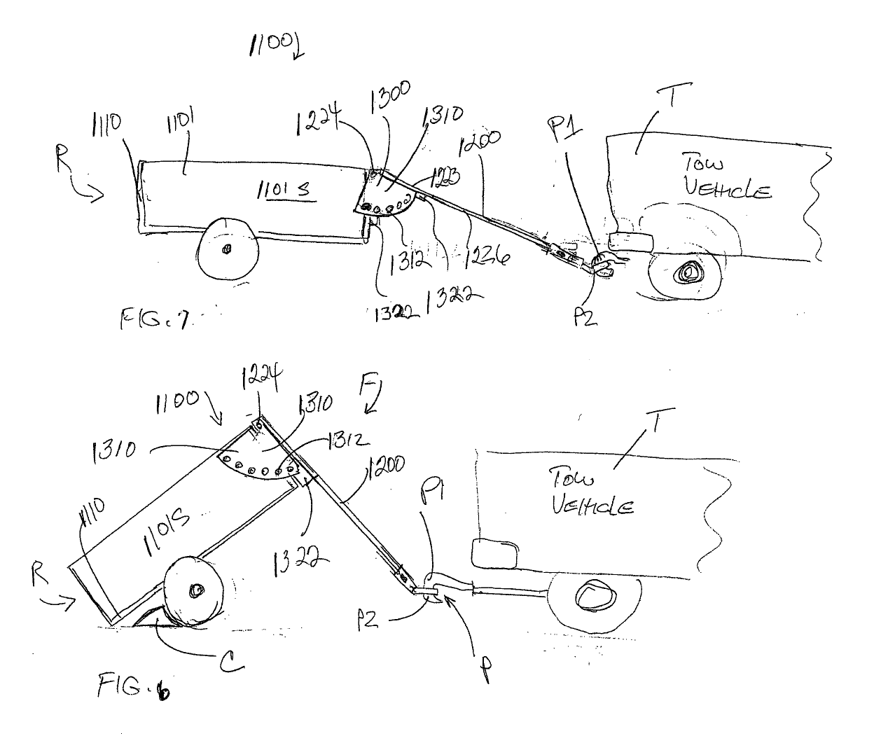

FIGS. 5A and 5B illustrate an alternative tow bar assembly 200′ in which the extension bar 220 is slidingly inserted into a receiver bar 222. The receiver bar 222 is fixedly mounted between the forward end 201C of the dual bars 201A, 201B. Both the receiver bar 222 and the extension bar 220 have tow-bar adjustment holes 201D. The overall length of the tow bar assembly 200 is adjusted by sliding the extension bar 220 out of the receiver bar 222 to the desired length and securing the extension bar 220 to the receiver bar 222 by passing a locking pin 201E through the tow-bar adjustment holes 201D.

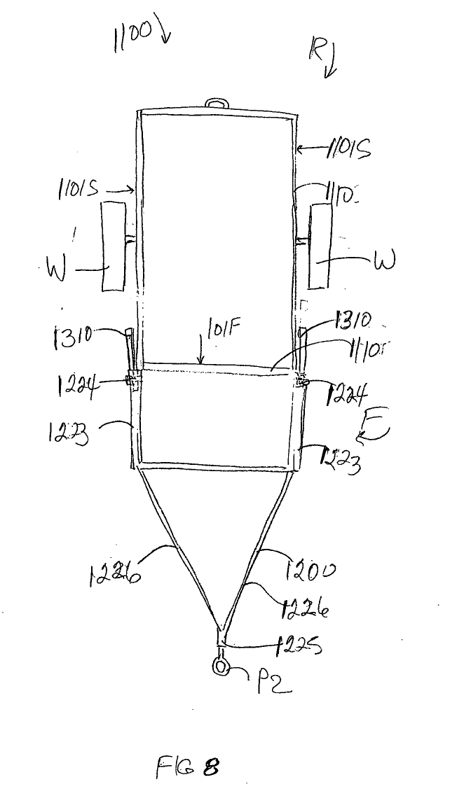

FIGS. 6 and 7 illustrate a first alternative embodiment of a dump trailer 1100 according to the invention, shown hitched to the tow vehicle T. The dump trailer 1100 may be a conventional or customized trailer with an undercarriage support that allows the trailer body to pivot about the single axle A. FIG. 6 shows the dump trailer 1100 in a dump position and FIG. 7 shows it in a tow position. The dump trailer 1100 comprises a frame 1110, trailer walls 1101, a tow bar assembly 1200, and, in this embodiment, a tilt-control means 1300. The trailer walls 1101 include right and left side walls 1101S. In this embodiment, the dump trailer 1100 is hitched to the tow vehicle T by means of a conventional pintle coupler P having a pintle hook P1 and an eye P2.

FIG. 8 illustrates the configuration of the tow bar assembly 1200, which includes two lower bars 1226 that converge at a hitch end 1225, and two upper bars 1223 that extend parallel to the sidewalls 1101S. The upper bars 1223 are each pivotably connected to the front end F of the frame 1110 by a pivot attachment means 1220, indicated generally by a pivot anchor 1224 and are rigidly connected at the other end to the respective lower bars 1226. The tilt-control means 1300 are mounted on the upper bars 1223 of the tow bar assembly 1200. The position of the tilt-control means 1300 varies with the degree of tilt of the dump trailer 1100, as best seen in FIGS. 6 and 7. In this FIG. 8, the dump trailer 1100 is in the tow position and a portion of the tilt-control means 1300 is visible on each side of the dump trailer 1100.

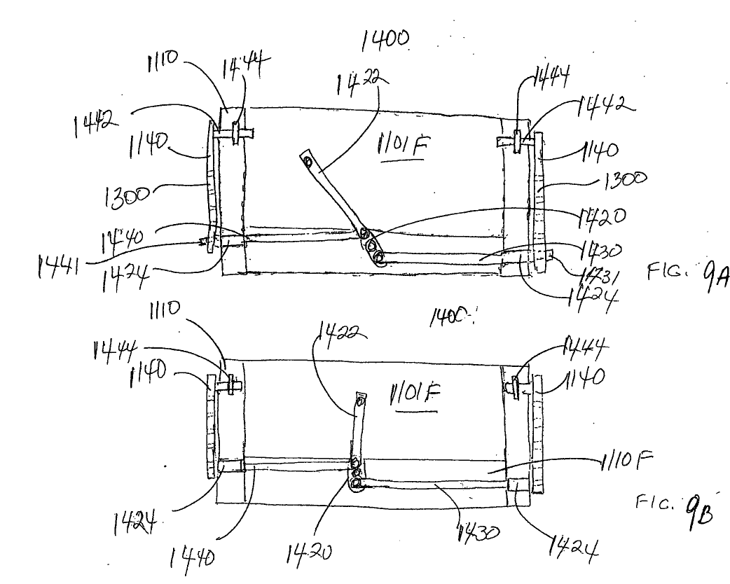

FIGS. 9A and 9B illustrate a tilt-locking assembly 1400 that is used to lock the tilt-control means 1300 to secure a particular degree of tilt of the dump trailer 1200. The tilt-locking assembly 1400 comprises a first locking bar 1430 and a second locking bar 1440 that are pivotably mounted on a pivot strap 1420. The pivot strap 1420 is rotatably mounted on the frame 1110. Locking-bar guides 1424 are also provided on the frame 1110, one on each side of the dump trailer 1100. A lever 1422 is used to move the tilt-locking assembly 1400 from a locking position, shown in FIG. 9A, to a released position, shown in FIG. 9B. The tilt-control means 1300 comprises a pair of tilt-control plates 1310, one mounted on each side of the dump trailer 1100 at the upper end of the tow bar assembly 1200. As illustrated in FIGS. 6 and 7, the tilt-control plates 1310 are fixedly connected to the respective upper bars 1223 and, as the tow bar assembly 1200 pivots about the pivot anchors 1224 and changes from a tow position, shown in FIG. 7, to a dump position, shown in FIG. 6, the tilt-control plates 1310 swing along side and parallel to the body of the dump trailer 1100. Holes 1312 are provided along the perimeter of the tilt-control plates 1310 for receiving the ends 1431 and 1441, respectively, of the first locking bar 1430 and the second locking bar 1440. The locking bar guides 1424 are provided in close proximity to the edge of the frame 1110 to capture the locking bars 1430/1440 and hold them properly aligned as they are shifted between the locking and release positions.

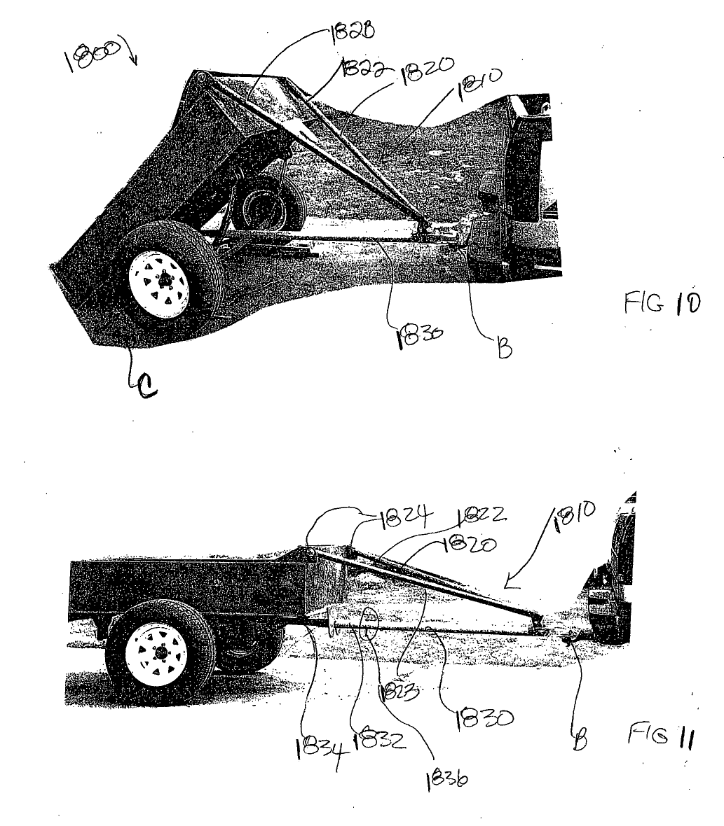

Operation of the first alternative embodiment of the dump trailer 1100 according to the invention is as follows: The dump trailer 1100 is connected to the pintle P1 of the pintle coupler on the tow vehicle T by means of the eye P2 on the hitch end 1225 of the tow bar assembly 1200. The tow bar assembly 1200 is a rigid assembly and, as the tow vehicle T moves forward, the dump trailer 1100 is pulled along. To bring the dump trailer 1100 to a dump position, the wheels W of the dump trailer are blocked from rolling rearward. A wheel chock C is shown in FIG. 11 for reasons of simplicity in illustration, but it is understood that the dump trailer 1100 may just as well be equipped with electrical, mechanical, or hydraulic brakes that are actuated from the tow vehicle T. The tilt-locking assembly 1400 is released, so that the tilt-control plates 1310 are free to swing as the tow bar assembly 1200 changes in tilt orientation. With the wheels of the trailer blocked, the tow vehicle T now simply backs up toward the dump trailer 1100. The pivot means 1220 allows the upper end of the tow bar assembly 1200 to pivot, thereby changing the angle of the tow bar assembly 1200 to a more vertical orientation to accommodate the shortening distance between the tow vehicle T and the dump trailer 1100. This forces the body of the dump trailer 1100 to pivot about its axle, effectively raising the front end F and lowering the rear end R of the dump trailer 1100. When the dump position is no longer required, the tow vehicle T is simply moved forward. The tow bar assembly 1200 is pulled to a more horizontal orientation, thereby pulling the front end F of the dump trailer 1100 down to its normal position.

FIGS. 10 and 11 illustrate a third embodiment of a dump trailer 1800 according to the invention. dump trailer 1800 embodies a simple construction that is particularly suited when the tow vehicle T is equipped with a ball hitch B. The configuration of the ball hitch B requires that the hitch on the trailer remain horizontal. The dump trailer 1800 is a conventional trailer that has been modified to function as a dump trailer. A tow bar assembly 1810 includes a telescoping tow bar 1830 comprising a first bar 1832 and a second bar 1834. The two bars 1832/1834 are dimensioned such that the second bar 1834 is slidably insertable within the first bar 1832. One end of the telescoping tow bar 1830 is hitched to the ball hitch B on the tow vehicle T; the other end is fixedly attached to a point on the underside of the trailer. Connected to the telescoping tow bar 1830 is a tilt means 1820 that is pivotably attached at one end to the tow bar 1830 and pivotably attached at the other end via a pivot anchor 1824 to the body of the dump trailer 1800. In the embodiment shown, the tilt means 1820 includes two push rods 1822 and 1823 that are fixed in a V-shaped configuration.

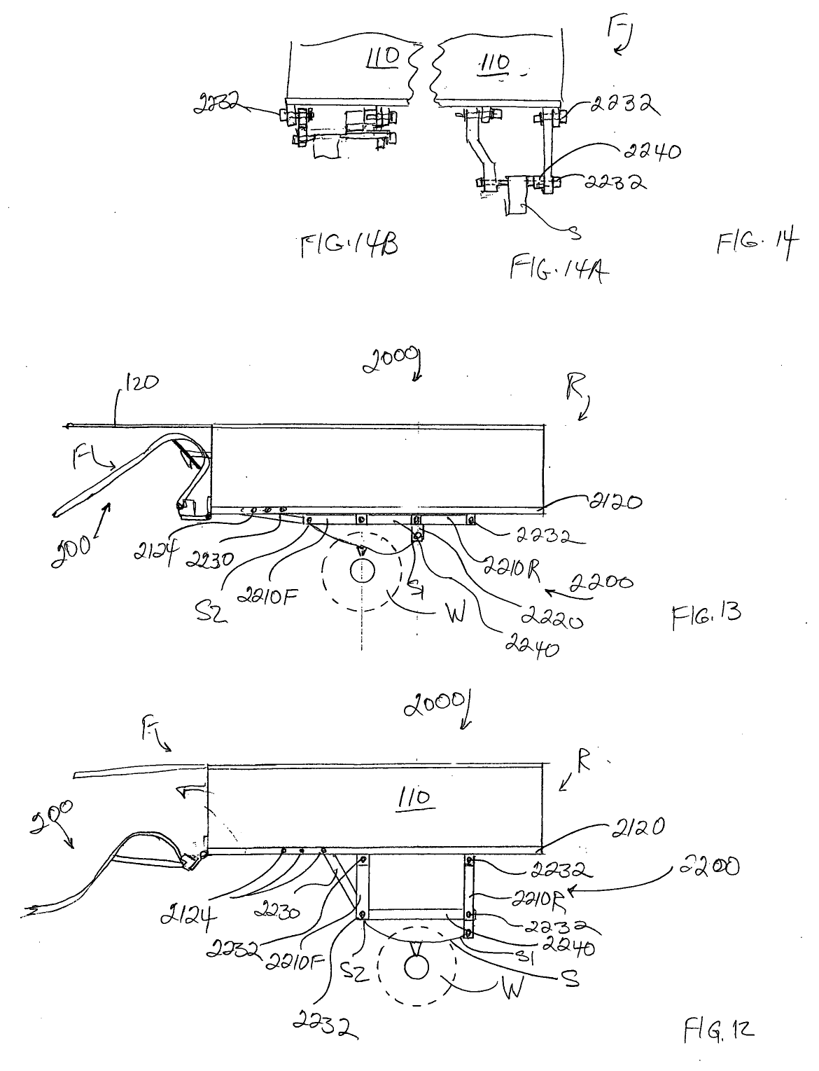

To move the dump trailer 1800 into the dump position, the wheels W are prevented from rolling rearward by some suitable means. In the illustration shown, wheel chocks C are placed behind the wheels W, although it is understood, that other conventional means of applying brakes to the wheels, such as mechanical, electrical, or hydraulic brakes that are actuated from the tow vehicle T, are included within the scope of the invention. A safety lock 1836, shown in FIG. 14, is used to secure the length of the telescoping tow bar 630 when the dump trailer 1800 is not being used for dumping. This safety lock 1836 is removed to release the telescoping function of the tow bar 1830. The tow vehicle T backs up toward the dump trailer 1800. The force against the tow bar assembly 1810 forces the first tow bar 1832 to slide over the second tow bar 1834, thereby shortening the distance between the tow vehicle T and the dump trailer 1800. The tilt means 1820, being pivotably mounted on the tow bar 1830 and the body of the dump trailer 1800 is forced to a more vertical orientation. This effectively raises the front end F and lowers the rear end R of the dump trailer 1800, as shown in FIG. 13.

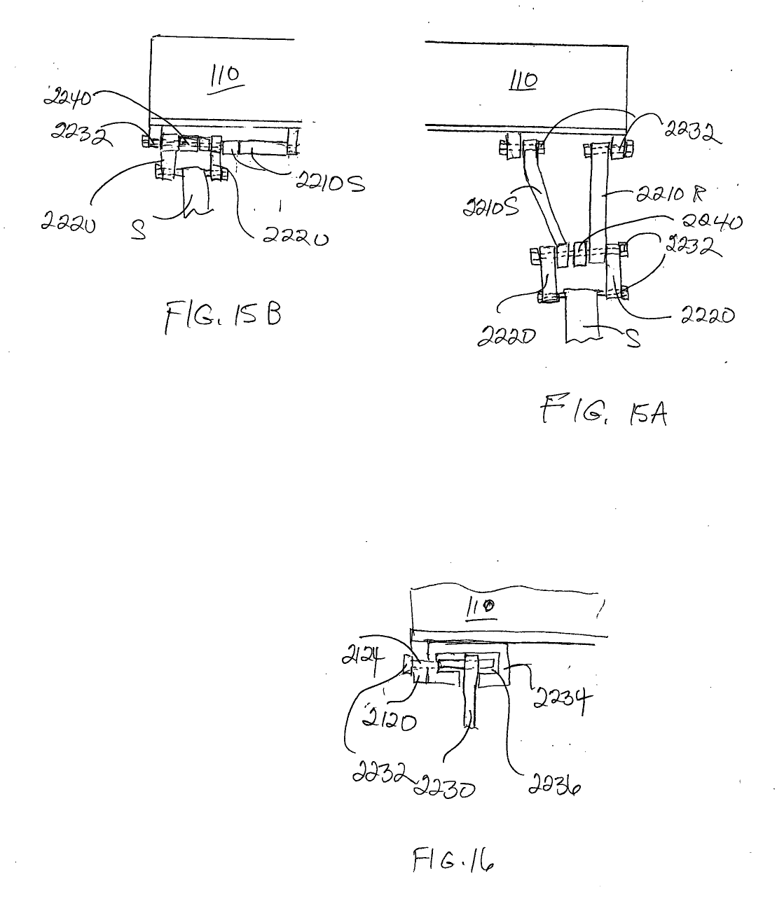

FIGS. 12-16 illustrate a height-adjustable trailer 2000. The utility of the elevation sub-structure 2200 is to elevate the body of the height-adjustable trailer 2000, so that it may be tilted to a 45 degree angle, to facilitate the removal of material during dumping. The elevation sub-structure 2200 is generally not required for use with the small lawn trailer. A conventional trailer with a body 8 feet or longer normally cannot be tilted to a 45-degree angle because the rear end of the trailer body hits the ground at a lesser angle. The 45-degree angle is the optimum angle for dumping, however, and the elevation sub-structure 2200 according to the invention allows an operator to raise the trailer body above the axle structure so that, when dumped, the rear end of the trailer hits the ground when the body is tilted approximately 45-degrees.

The height-adjustable trailer 2000 shown in FIGS. 12-16 is the dump trailer 100 of FIGS. 1-3 above, but it is understood that the elevation sub-structure 2000 may be provided with any conventional single-axle trailer. The elevating sub-structure 2200 is assembled on a conventional leaf spring assembly S of the trailer 2000. The leaf spring assembly S is mounted on the axle A and is normally connected to a trailer bed side rail 2120 of the trailer 2000 at respective ends of the spring assembly S1 and S2. The sub-structure 2200 according to the invention is mounted on the spring ends S1 and S2 of the leaf spring assembly S and connects to the side rail 2120. It is understood that the elevating sub-structure 2200 is assembled on the leaf spring assembly Son each side of the body 110 of the dump trailer 100. The trailer bed side rail 2120 has a groove (not shown) that runs along a portion of the inside of the rail and a series of locking holes 2124 along another portion of the rail 2120. The elevation sub-structure 2200 comprises an arrangement of bars that are pivotably connected to each other by a conventional pivot means, generally referred to as 2232 and are swingable between a deployed state and a collapsed state, shown in FIGS. 12 and 13. The bars include a front swing arm 2210F, a rear swing arm 2210R, a horizontal bar 2240, an extension bar 2220, and a slide arm 2230. A front end of the horizontal bar 2240 is pivotably connected to the spring end S2 and a lower end of the extension bar 2220 to the spring end S1. The upper end of the extension bar 2220 is pivotably connected to the rear end of the horizontal bar 2240. The length of the horizontal bar 2240 is approximately equal to the distance between the spring ends S1,S2 when they are connected in a conventional manner to the underside of the trailer body 110. The front swing arm 2210F and the rear swing arm 2210R are each connected at their respective lower ends to the horizontal bar 2240 and at their respective upper ends to a pivot connection 2232 that are at fixed points on the side rail 2120. The lower end of the slide bar 2230 is pivotably connected to the spring end S2 and has an upper end 2231 that is slidingly captured in a groove 2236 in a capture rail 2234 that is mounted alongside the side rail 2120. The elevation sub-structure 2200 may be locked into the deployed state by aligned the forward end of the slide arm 2230 at the desired locking hole 2124 and inserting a pin through the respective locking hole 2124 and a through-hole in the upper end of the slide arm 2230.

Deployment of the elevation sub-structure 2200 uses the power of the tow vehicle T to bring the trailer body 110 into a tilted position. The wheels W are prevented from rolling backward by placing a wheel chock or otherwise locking the wheels, the tow bar assembly 200 attached to the tow vehicle T, and the tow vehicle T backed toward the front end F of the trailer body 110 until the rear end R of the trailer body 110 is forced against the ground. With the rear end of the trailer body 110 resting on the ground, the weight of the trailer body 110 is lifted from the wheels W and the slide arm 2230 of the elevation sub-structure 2200 may be easily slid in the groove 2236 of the capture rail 2234 until a through-hole in the slide arm 2230 aligns with a desired one of the locking holes 2124 in the side rail 2120. The capture rail 2234 is best seen in FIG. 16. The locking pin is the insertable through the locking hole 2124 and the through-bore to secure the slide arm 2230 in the desired position, holding the elevation sub-structure 2200 in a deployed state. When the dump maneuver is completed, the locking pin is removed. Now, when the tow vehicle T moves forward, it pulls elevation sub-structure 2200 into the collapsed state and the trailer body 110 is again in its nomal horizontal orientation.

It is understood that the embodiments described herein are merely illustrative of the present invention. Variations in the construction of the trailer, the tow bar assembly, and the elevation sub-structure may be contemplated by one skilled in the art without limiting the intended scope of the invention herein disclosed and as defined by the following claims.

1. A dump trailer comprising:
a trailer body mounted on an axle, the trailer body having side walls, a trailer bottom, a front side and a rear side, wherein a front end of said trailer body encompasses said front side and, in close proximity to said front side, a portion of said side walls and a front portion of said trailer bottom;
a tow bar assembly having a push bar of fixed length and a tow bar that is adjustable in length, wherein said push bar has a first push-bar end that is pivotably attached to said front end of said trailer and a second push-bar end that is attached to said tow bar, and wherein said tow bar has a tow end that is hitchable to a tow hitch on a tow vehicle.

2. The dump trailer of claim 1 further comprising an auxiliary wheel that is assembled on said tow bar assembly so as to provide support for said tow bar assembly when said tow bar assembly is not hitched to a tow vehicle, such that said trailer body is maintained in a substantially horizontal position.

3. The dump trailer of claim 2, wherein said auxiliary wheel is mounted on said tow bar;
wherein said tow bar is axially aligned with and swingably mounted on said second push-bar end and is axially rotatable about a pivot point between a tow position and a non-tow position; and
wherein, when in said tow position, said tow bar is facing outward from said trailer body and, when in said non-tow position, said tow bar is rotated about said pivot point such that said auxiliary wheel supports said tow bar assembly on a ground surface and said tow end of said tow bar is facing toward said trailer body.

4. The dump trailer of claim 1, wherein said first end of said push bar is pivotably connected to said front side.

5. The dump trailer of claim 4, wherein said push bar includes a forked push-bar assembly with two push bars, each with said first push-bar end and said second push-bar end, wherein said tow push bars are spaced apart at said front side of said trailer body, and wherein, at said second push-bar end, said two push bars are mounted to said tow bar, one of said two push bars on each side of said tow bar.

6. The dump trailer of claim 5 further comprising a latch means that includes a first latch element on said front side of said trailer body and a second latch element on said push bar and wherein, when said tow bar assembly is in said non-tow position, said first latch element catches on said second latch element to lock said tow bar assembly in said non-tow positioin.

7. The dump trailer of claim 6, wherein said first latch element is a hook means and said second latch element is a crossbar mounted between said tow push bars.

8. The dump trailer of claim 1, wherein said handlebar has two ends with an intermediate portion therebetween, wherein said two ends are connected to said front end of said trailer body one of said two ends on each side of said trailer body, wherein said intermediate portion extends substantially parallel to a horizontal plane of said trailer; and wherein a work surface is mounted on said intermediate portion of said handlebar.

9. The dump trailer of claim 8, wherein said work surface is fixedly mounted on said handlebar.

10. The dump trailer of claim 9, wherein a bottom contour of said work surface is formed to removably seat said work surface on said handlebar.

11. The dump trailer of claim 1 further comprising a collapsible elevation sub-structure, wherein said dump trailer has a single axle with a leaf spring mounted thereon, said leaf spring having a first spring end and a second spring end, and wherein said elevation sub-structure is collapsibly mounted on said spring ends and is deployable to an elevated state in which said trailer body is raised up a distance above said axle and to a collapsed state in which said trailer body is maintained at a normal distance from said axle.

12. The dump trailer of claim 4, wherein said collapsible elevation sub-structure comprises elevation means pivotably mounted between said first spring end and said trailer body and between said second spring end and said trailer body, and a horizontal bar pivotably mounted between said elevation pivot means.

13. The dump trailer fo claim 5, said elevation sub-structure further comprising a position locking means for locking said collapsible elevation means in an elevated position.

14. A dump trailer for use with a ball tow hitch, said dump trailer comprising:
a trailer body mounted on an axle, the trailer body having side walls, a trailer bottom, a front side and a rear side, and a front end encompassing said front side and, in close proximity to said front side, a portion of said side walls and a front portion of said trailer bottom;
a tow bar assembly having a fixed-length push bar and an adjustable-length tow means, wherein said fixed-length push bar has a first end that is pivotably attached to said front end of said trailer and a second end that is pivotably attached to said tow bar, and wherein said tow bar has a first tow bar end that is fixedly attached to said trailer bottom and a second tow bar end that is hitchable to a ball of a tow hitch on a tow vehicle.

15. The dump trailer of claim 7, wherein said tow-bar is a telescoping tow bar.
